(19) United States
(12) Patent Application Publication
(10) Pub. No.: US 2026/0111518 A1
(43) Pub. Date: Apr. 23, 2026

(54) DIGITAL RIGHTS MANAGEMENT

(71) Applicant: Notion Labs, Inc., San Francisco, CA (US)

(72) Inventors: Vincent A. William Budrovich, III, San Francisco, CA (US); Christina Y. Lin, San Francisco, CA (US); Samuel Baker Catania, San Francisco, CA (US); Sarah Lim, San Francisco, CA (US); Garrett Fidalgo, San Francisco, CA (US)

(21) Appl. No.: 18/923,317

(22) Filed: Oct. 22, 2024

(51) Int. Cl. G06F 21/10

(52) U.S. Cl. CPC G06F 21/107

(57) ABSTRACT

Methods and devices for flexible control and management of digital content are disclosed. In one example aspect, a method of digital rights management includes receiving a request from a user for copying information on a source page in a source workspace to a target page in a target workspace, initiating a process to copy the information to the target page. The process includes determining, for a block of the information in the source page, that the target workspace has a license for copying the block. The process also includes associating a record of the block with the target workspace.

### BACKGROUND

Workspaces (e.g., digital workspaces) refer to environments that assemble tools and platforms that allow users to work, communicate, and produce work products together. Workspaces can be desktop or web-based applications that allow multiple users to share and access the workspaces in a variety of manners.

### BRIEF DESCRIPTION OF THE DRAWINGS

Reference will now be made, by way of example, to the accompanying drawings, which show example embodiments of the present application and in which:

FIG. 1 is a block diagram of an example platform that leverages a block data model in accordance with one or more embodiments of the present technology.

FIG. 2A is a block diagram illustrating a hierarchical organization of pages in a workspace in accordance with one or more embodiments of the present technology.

FIG. 2B is a block diagram illustrating a hierarchical organization of blocks in a page in accordance with one or more embodiments of the present technology.

FIG. 3A illustrates an example template at a page level in accordance with one or more embodiments of the present technology.

FIG. 3B illustrates an example library module at a block level in accordance with one or more embodiments of the present technology.

FIG. 4 is a flowchart representation of a computer-implemented method of digital rights management for content in accordance with one or more embodiments of the present technology.

FIG. 5 is an example flow for installing a template or a library module in accordance with one or more embodiments of the present technology.

FIG. 6 is a flowchart representation of a computer-implemented method of digital rights management for content in accordance with one or more embodiments of the present technology.

FIG. 7 is an example flow for duplicating a template or a library in accordance with one or more embodiments of the present technology.

FIG. 8 illustrates an example user interface that prompts a user to view and purchase a template in accordance with one or more embodiments of the present technology.

FIG. 9 illustrates an example user interface that shows a warning message to a user in accordance with one or more embodiments of the present technology.

FIG. 10 is a flowchart representation of a method of digital rights management for content in accordance with one or more embodiments of the present technology.

FIG. 11 illustrates an example page after a user requests a refund of a license in accordance with one or more embodiments of the present technology.

FIG. 12 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Section headings are used in the present document only to improve readability and do not limit the scope of the disclosed embodiments and techniques in each section to only that section.

Digital rights arise through the creation and publication of digital content, such as templates and/or libraries. It is important to control and manage access to such digital content so that content creators can properly monetize their creations and be incentivized to continue their efforts. This patent document discloses techniques that enable flexible control and management of digital content, such as templates and/or libraries, to ensure proper copying or distribution of the content. The disclosed techniques can also be implemented in various embodiments to timely disable the content when a corresponding license is revoked or expires.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc. are all blocks in a workspace. The attributes of a block determine how that information is rendered and organized. Every block can have attributes, including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children is referred to herein as a “render tree.” In one example, page blocks display their content in a new page instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer” the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, like blocks, users, workspaces, etc. Because many actions usually change more than one record, operations are batched into transactions that are committed (or rejected) by the server as a group.

Creating and updating blocks can be performed by, for example, pressing enter on a keyboard. First, the client defines all the initial attributes of the block, generating a new unique ID, setting the appropriate block type (to_do), and filling in the block's properties (an empty title and checked: [[“No”]]). The client builds operations to represent the creation of a new block with those attributes. New blocks are not created in isolation: blocks are also added to their parent's content array so they are in the correct position in the content tree. As such, the client also generates an operation to do so. All these individual change operations are grouped into a transaction. Then, the client applies the operations in the transaction to its local state. New block objects are created in memory, and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to share with others. Usually, TransactionQueue sits empty, so the transaction to create the block is sent to the server in an API request. In one example, the transaction data is serialized to JSON and posted to the /saveTransactions API endpoint. SaveTransactions gets the data into source-of-truth databases, which store all block data, as well as other kinds of persisted records. Once the request reaches the API server, all the blocks and parents involved in the transaction are loaded. This gives a “before” picture in memory. The block model duplicates the “before” data that had just been loaded in memory. Then, the block model applies the operations in the transaction to the new copy to create the “after” data. Then, the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to MessageStore, which is a real-time updates service. When the client renders a block (or page or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of newly recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, it sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

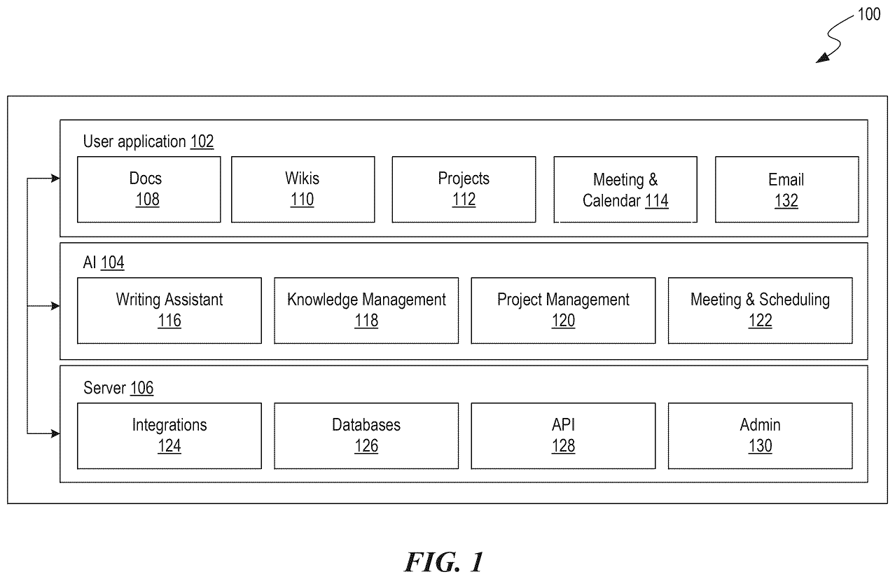

FIG. 1 is a block diagram of an example platform 100 that leverages the block data model. The platform 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading) or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as artificial intelligence-extracted properties, and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The AI tool 104 is an integrated AI assistant that enables AI-based functions for the user application 102. In one example, the AI tool 104 is based on a neural network architecture. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include auto filling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Templates and Libraries

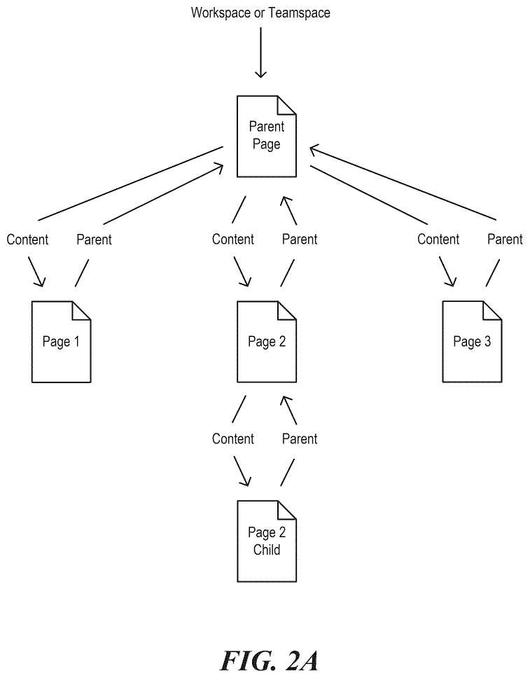

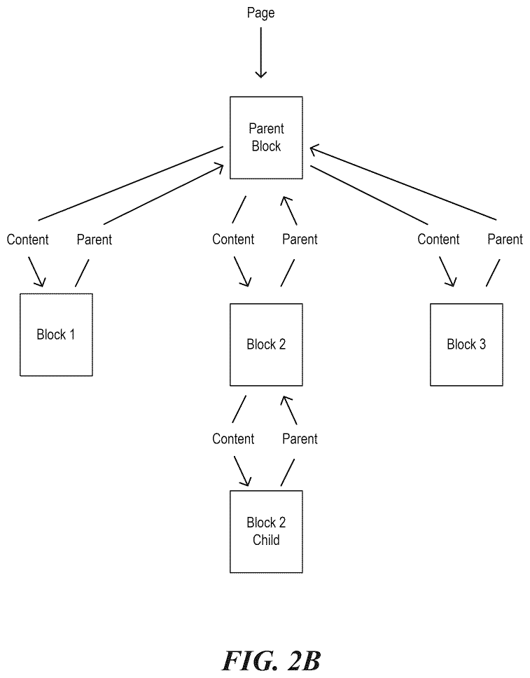

Workspaces and teamspaces can be organized hierarchically. FIG. 2A is a block diagram illustrating a hierarchical organization of pages in a workspace in accordance with one or more embodiments of the present technology. As described with respect to the block data model of the present technology, a workspace can include multiple pages (e.g., page blocks). The pages (e.g., including parent pages and child or nested pages) can be arranged hierarchically within the workspace or one or more teamspaces. Each page can include a block such as tabs, lists, images, tables, etc. For example, a workspace can include a teamspace accessible by all users of a division and multiple teamspaces that are accessible by users of different teams in the division. Accessibility generally refers to creating, editing, and/or viewing content (e.g., pages) included in the workspace or the one or more teamspaces.

In the hierarchical organization illustrated in FIG. 2A, a parent page (e.g., “Parent Page”) is located hierarchically below the workspace or the teamspace. The parent page includes three child pages (e.g., “Page 1,” “Page 2,” and “Page 3”). Each of the child pages can further include subpages (e.g., “Page 2 Child,” which is a grandchild of “Parent Page” and child of “Page 2”). The “Content” arrows in FIG. 2A indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

At the page level, content in a page can also be organized hierarchically. FIG. 2B is a block diagram illustrating a hierarchical organization of blocks in a page in accordance with one or more embodiments of the present technology. A parent block (e.g., “Parent Block”) is located hierarchically below a page. The parent block includes three child blocks (e.g., “Block 1,” “Block 2,” and “Block 3”). Each of the child blocks can further include child blocks (e.g., “Block 2 Child,” which is a grandchild of “Parent Block” and child of “Block 2”). The child blocks inherit access permission from the (immediate) parent block under which they are located hierarchically (e.g., which is above them in the tree).

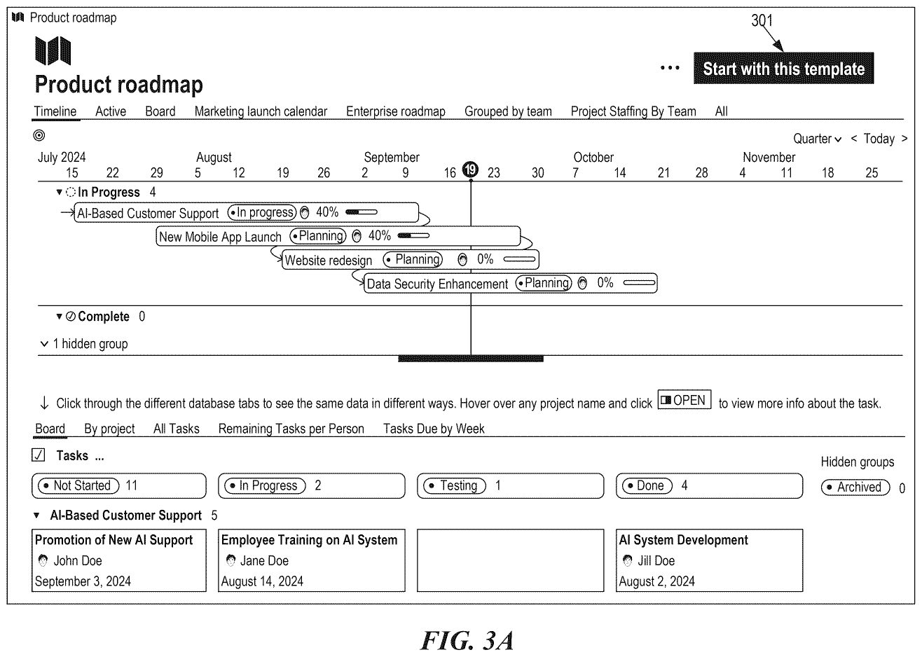

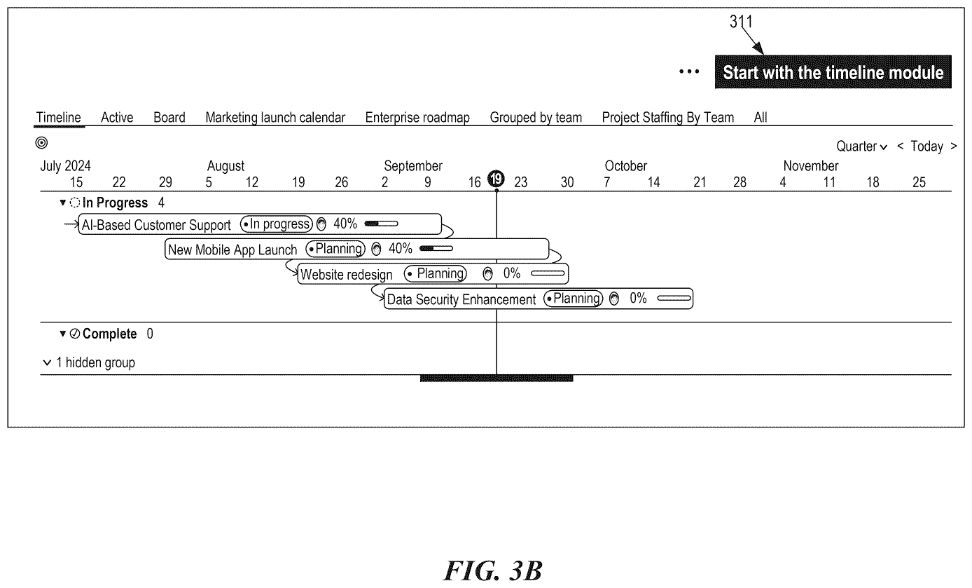

The hierarchical structure of the blocks enables the creation of templates or libraries of blocks that can be reused across different pages, teamspaces, or workspaces. FIG. 3A illustrates an example template at a page level in accordance with one or more embodiments of the present technology. The example product roadmap template can be installed at the page level (e.g., installed as a new page under a teamspace or a workspace). The template includes a hierarchy of blocks, some related to the timeline of the projects and some related to the tasks assigned to the team members. After the template is installed, the user is free to update or modify the content of the blocks.

In some cases, the user may not want to adopt the complete layout of a template and may prefer to have smaller modules that can be installed to a portion of the page. A hierarchy of blocks then can be grouped as a library module to enable reuse of the designs of the blocks. Multiple library modules can form a library, and the user can select one or more modules from the library for use in the user's workspace(s). FIG. 3B illustrates an example library module at a block level in accordance with one or more embodiments of the present technology. In this example, the timeline library module can be selected from a library of modules, each comprising a hierarchy of blocks, to be installed to a portion of the page (e.g., an event organizing page).

### Digital Rights Management (DRM)

When a content creator creates a hierarchy of blocks to form a template or library module, the blocks in the hierarchical structure can be labeled as DRM blocks. In some embodiments, not all the blocks in the hierarchical structure are considered as DRM blocks. For example, blocks with simple texts may not be DRM blocks. On the other hand, blocks representing complex data structures (e.g., integrations, embedded information) are DRM blocks. In some embodiments, different DRM profiles can be used, each representing a particular type of DRM content (e.g., calendar profile, project management profile, etc.).

Operations on the DRM blocks can require specific license(s) from the users. Past operations can also be stored as records to ensure proper tracking and management of the DRM blocks. When the created content is available for installation or distribution, the blocks can be examined to determine whether they are DRM blocks associated with specific license(s) to enable proper management of the content.

Referring back to FIG. 3A, the blocks in the example product roadmap template are marked as DRM blocks. When a user wants to install this template, the user can click on button 301 to install it to a target workspace (e.g., the user's own workspace). Similarly, in FIG. 3B, the user can click on button 311 to install the library module to a page in the target workspace. Upon receiving the request to install from the user, the platform can determine whether the target workspace has the proper license for the DRM blocks in the template/library module.

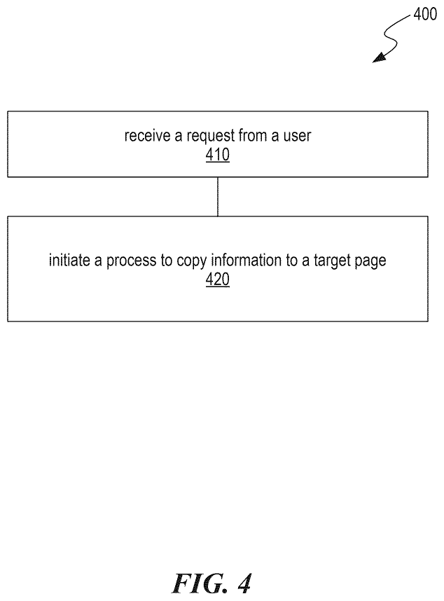

FIG. 4 is a flowchart representation of a computer-implemented method of digital rights management for content in accordance with one or more embodiments of the present technology. The method 400 includes, at operation 410, receiving a request from a user for copying information on a source page in a source workspace to a target page in a target workspace. The source page comprises a hierarchical structure of blocks that includes at least a preset format of one or more blocks (e.g., a template or a library module). The method 400 includes, at operation 420, initiating a process to copy the information to the target page. The process includes determining, for a block in the preset format of one or more blocks, that the target workspace has a license for copying the block. The process also includes associating a record of the block with the target workspace after the target workspace is determined.

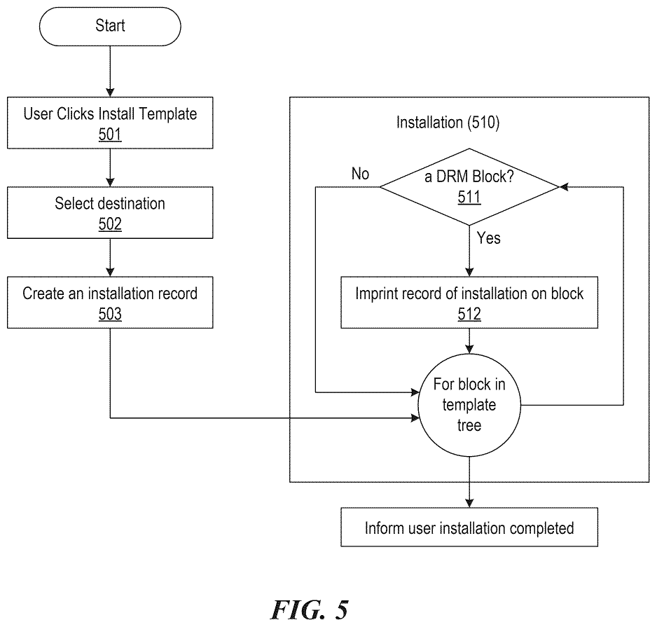

FIG. 5 is an example flow for installing a template or a library module in accordance with one or more embodiments of the present technology. In this example, the user clicks on an “install” button (e.g., button 301 as shown in FIG. 3A or button 311 as shown in FIG. 3B) at operation 501 to purchase a license that allows the installation of the template or the library module. The user also selects a destination (e.g., a target workspace) for the installation at operation 502. In this example, a template is installed to a new page in the target workspace. If the user selects to install a library module, the user can specify an existing page in the target workspace to install the library. The platform creates an installation record to track this installation activity at operation 503 and initiates the installation process 510. The installation record can include information associated with the appropriate license for the installation and/or use of the template/library module.

With the appropriate license for the installation process 510, the platform examines, for each block in the hierarchical tree of the template at operation 511, whether the block is a DRM block. If a block is not a DRM block, no special action is needed for the block and the block can be copied to the destination. If a block is a DRM block, an install record can be created and be associated with the block at operation 512. The association of the record with the block is also referred to as “imprinting” the record. The platform can traverse the hierarchical tree structure of the template, e.g., in a breadth-first manner, until it examines all the blocks in the structure to determine that the installation completes.

The user obtains a license to install a template/library for use. In some cases, the user may want to duplicate the template, with or without modifications, so that the template/library module can be used in multiple workspaces. Some of the blocks in the modified template/library module are custom blocks added by the user and are thus not DRM blocks. The remaining blocks installed from the original template/library module are DRM blocks under the protection of license(s). The user can obtain a different type of license, or a license with a premium fee, in order to duplicate the template(s). If the license is not obtained, a block is not copied or displayed properly on the target page.

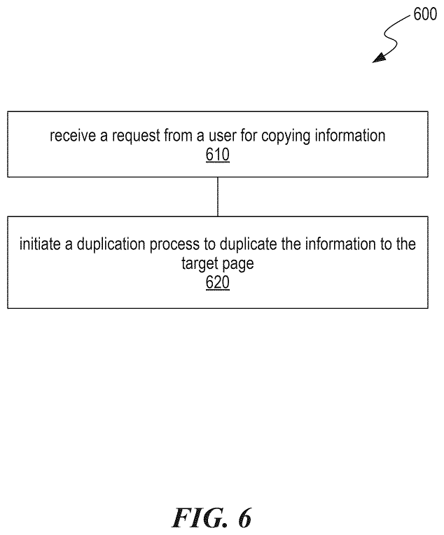

FIG. 6 is a flowchart representation of a computer-implemented method of digital rights management for content in accordance with one or more embodiments of the present technology. The method 600 includes, at operation 610, receiving a request from a user for copying information on a source page in a source workspace to a target page in a target workspace. The source page comprises a hierarchical structure of blocks that includes at least a preset format of one or more blocks. The method 600 includes, at operation 620, initiating a duplication process to duplicate the information to the target page. The information is duplicated to the target page when there is a proper license. In some embodiments, however, the license may not be proper. The duplication process includes determining, for a block in the preset format of one or more blocks, that the target workspace fails to have a license for duplicating the block. The duplication process includes replacing the block with a dummy block on the target page.

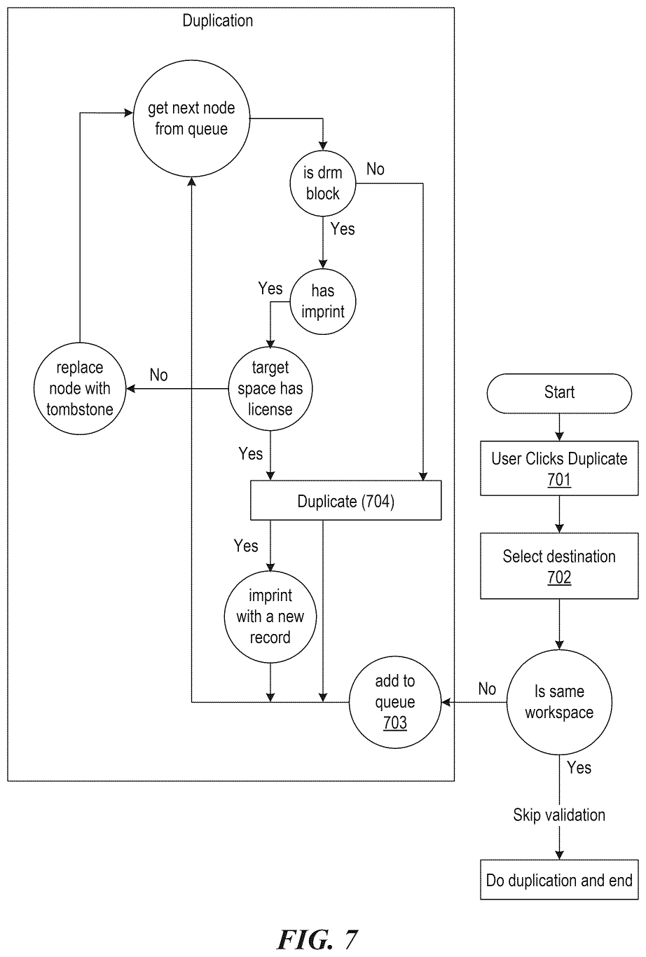

FIG. 7 is an example flow for duplicating a template or a library in accordance with one or more embodiments of the present technology. In this example, at operation 701, the user can request duplication of a template or library using a “duplication” button. The user also selects a destination (e.g., a target workspace) for the duplication at operation 702. The platform checks whether the target workspace is the same as the source workspace. In this example, if they are the same, the user already obtains the proper license to make the duplication (that is, the license allows duplications in the same workspace) and validation can be skipped. In some other cases, the original license may not allow any duplication, and the user needs to obtain a different license or pay for additional features to enable the duplication.

When validation needs to be performed to determine whether the target workspace has the appropriate license(s), the platform traverses the hierarchical structure of the template or a library module to add the blocks into a queue at operation 703. For each block in the queue, if the block is not a DRM block (e.g., a new block created by the user), the block is duplicated at operation 704 without performing any additional operation. If the block is a DRM block, the previously “imprinted” information about installation is retrieved to allow the platform to examine whether the target workspace has the appropriate license for the duplication. If the target workspace has the proper license for the duplication of the block, the record is updated, or a new record is created, to include the information about the duplication. The updated/new record is “imprinted” to the block so that the block is associated (“imprinted”) with the complete chain of installation/duplication operations. If the target workspace does not have the proper license for the duplication of the block, the block can be replaced by a dummy block (e.g., a “tombstone”) displayed on the target page.

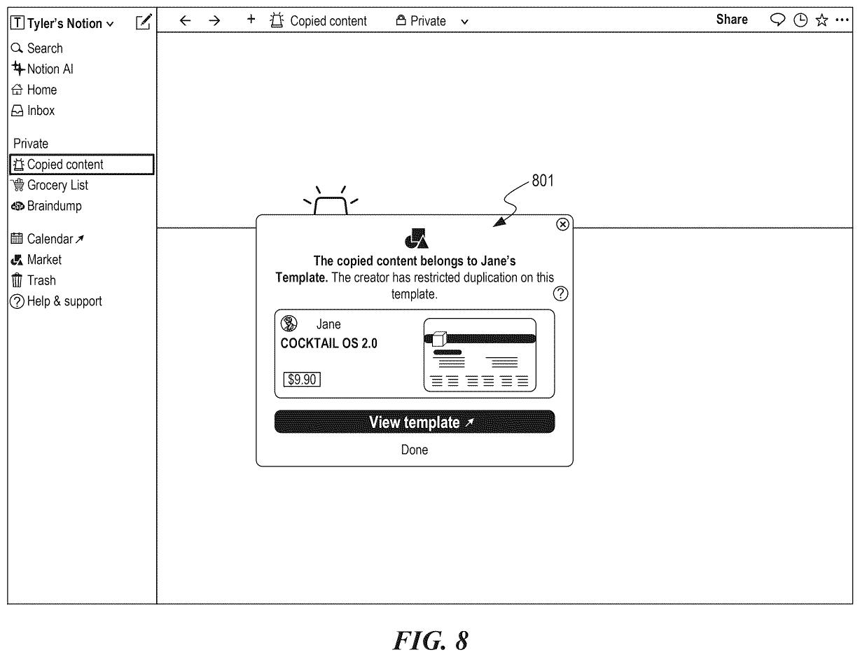

In some embodiments, when the target workspace does not have the appropriate license(s), the user can be prompted to purchase the required license(s). FIG. 8 illustrates an example user interface that prompts a user to view and purchase a template in accordance with one or more embodiments of the present technology. In this example, the user wants to copy an existing template or content that belongs to the existing template, and the template creator has restricted such operations. The platform checks the hierarchical structure of the template/content and decides that at least some of the blocks are DRM blocks under protection. The user is then provided with the prompt 801 and is directed to the template page via “View template” to complete purchase of the template.

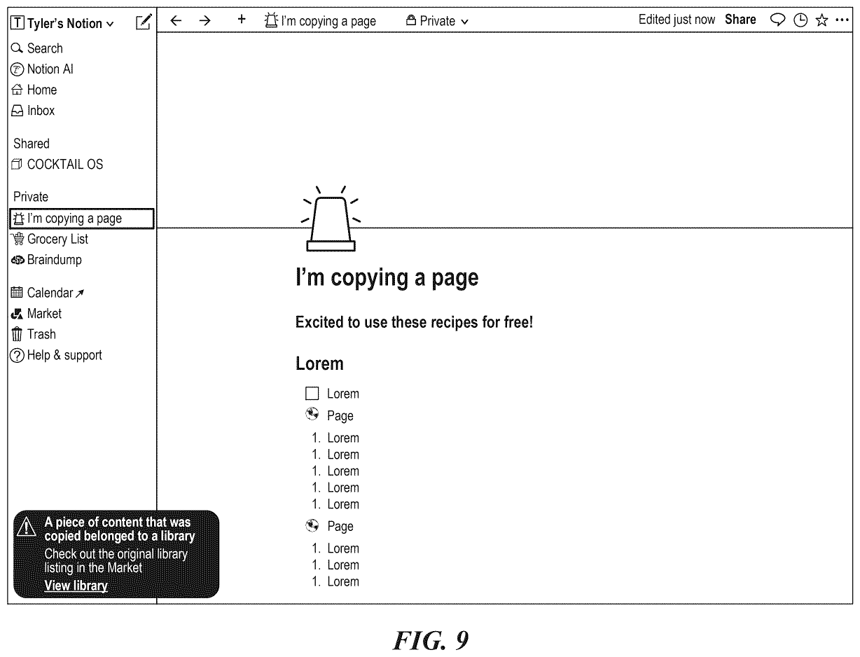

In some embodiments, instead of being directed to a page to purchase a license, the user is notified of the protected content after the duplication of the content. FIG. 9 illustrates an example user interface that shows a warning message to a user in accordance with one or more embodiments of the present technology. In this example, the user wants to copy some content that includes the use of library module(s). The content may include non-DRM blocks and DRM blocks associated with a library module. After the content is copied, part of the content now appears as “tombstone” blocks. A warning message is displayed to inform the user that the “tombstone” blocks belong to a library. A link can be provided to direct the user to the library to complete the purchase of the license for using the library modules.

As shown in the embodiments above, the disclosed techniques enable the protection of digital content at different levels of granularity (e.g., a large set of blocks as a template, or a smaller set of blocks as a library module). Content creators can associate different levels of licenses with the content to enable different access levels for content buyers, such as only allowing use after installation, allowing duplications within the same workspace after installation, allowing modification by adding more blocks (e.g., non-DRM blocks) to the template/module, allowing duplications across different workspaces, etc. Different access levels can be associated with different pricing levels to incentivize content creators to continue to generate content.

The “imprinting” of the installation/duplication records to the blocks also enables easy revocation of the access when a license expires or when content buyers change their minds. For example, a content buyer may purchase a license to use a library module and install/duplicate the library module in his or her workspace. Later, the content buyer submits a request for refund of the license fee. Once the license is revoked (e.g., due to the refund), the records associated with the blocks can indicate that there is no longer a license for the workspace/page, and the installed/duplicated library module can be displayed as “tombstone” to indicate that the content is no longer usable given that the license has been revoked.

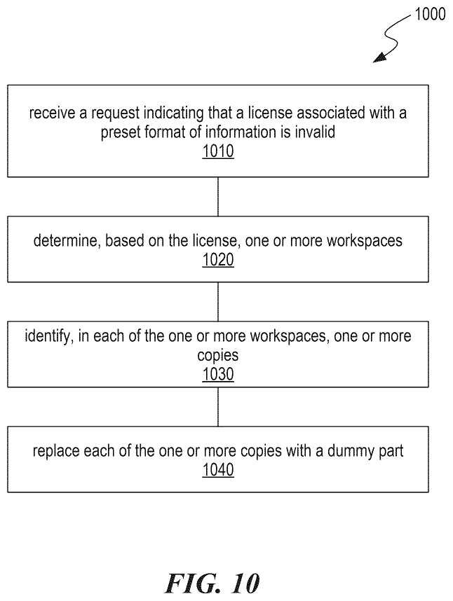

FIG. 10 is a flowchart representation of a method of digital rights management for content in accordance with one or more embodiments of the present technology. The method 1000 includes, at operation 1010, receiving a request indicating that a license associated with a preset format of information is invalid. The method 1000 includes, at operation 1020, determining, based on the license, one or more workspaces that have been granted a permission to use the preset format. The method 1000 includes, at operation 1030, identifying, in each of the one or more workspaces, one or more copies of at least part of the information included in the preset format. The method 1000 also includes, at operation 1040, replacing each of the one or more copies with a dummy part in each of the one or more workspaces.

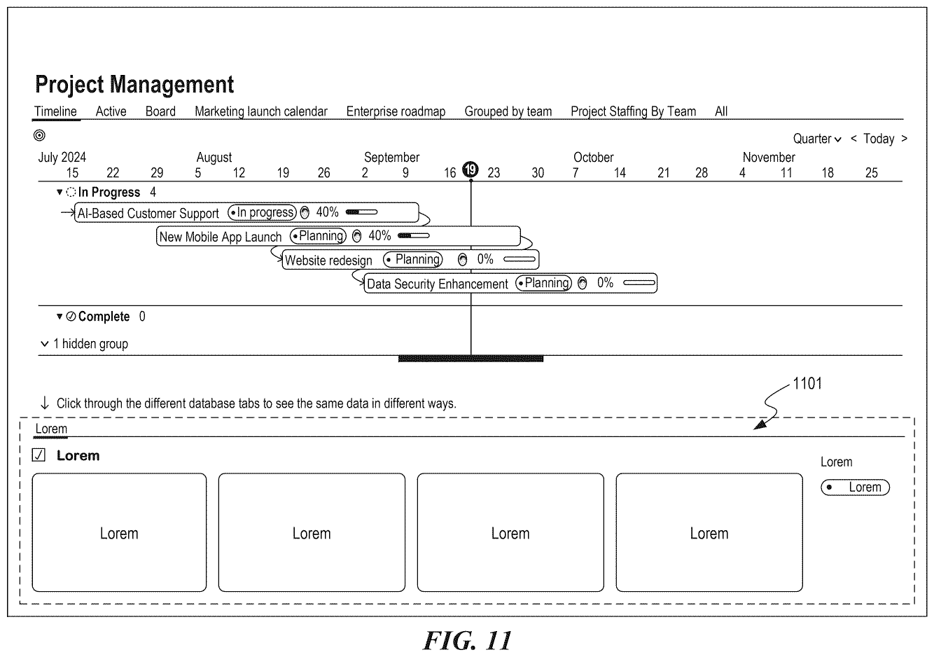

FIG. 11 illustrates an example page after a user requests a refund of a license in accordance with one or more embodiments of the present technology. The page shown in FIG. 11 is similar to the template shown in FIG. 3A but is built using two sets of library modules: the timeline module and the task module. The content buyer decides to request a refund for the task module 1101, thereby causing a revocation of the license for the task module. In some cases, the license is associated with a valid period and expires at the end of the period. When the license becomes invalid, the portion of the page where the task module was installed/copied now shows dummy blocks (“Lorem”), indicating that these blocks are no longer available. In some embodiments, an interface item, such as a link, can be provided to the user to prompt the user to consider renewing the license.

In some embodiments, the “imprinting” of the records can be performed without the use of the block-based hierarchical structure. For example, a template or a module that is implemented using a non-block approach can be associated with one or more installation/duplication records. Each of the records includes information regarding an installation or a duplication operation of the information at a certain location (e.g., a workspace, a page, or an application, either web-based or non-web-based). The records are associated with license information associated with a user. Once the license information changes (e.g., the license gets revoked), the rendering of the template or module can be updated accordingly to timely inform the user of the access status of the template/module.

### Computer System

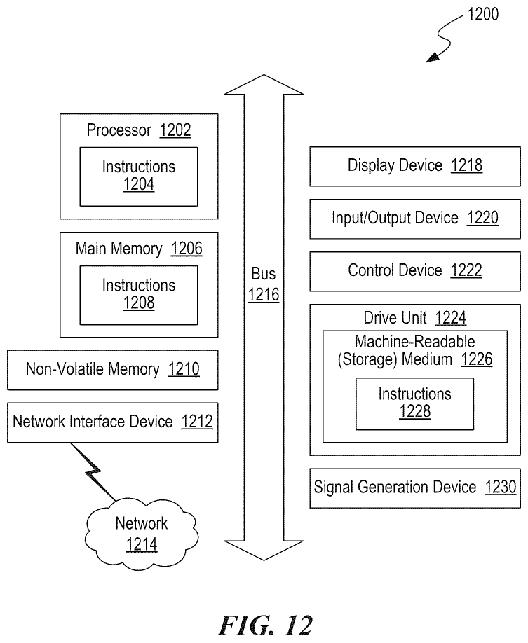

FIG. 12 is a block diagram that illustrates an example of a computer system 1200 in which at least some processes described herein can be implemented (e.g., methods described respectively with respect to FIGS. 4-7, FIG. 9). As shown, the computer system 1200 can include one or more processors 1202, main memory 1206, non-volatile memory 1210, a network interface device 1212, a display device 1218, an input/output device 1220, a control device 1222 (e.g., keyboard and pointing device), a drive unit 1224 that includes a machine-readable (storage) medium 1226, and a signal generation device 1230 that are communicatively connected to a bus 1216. The bus 1216 represents one or more physical buses and/or point-to-point connections that are connected by appropriate bridges, adapters, or controllers. Various common components (e.g., cache memory) are omitted from FIG. 12 for brevity. Instead, the computer system 1200 is intended to illustrate a hardware device on which components illustrated or described relative to the examples of the figures and any other components described in this specification can be implemented.

The computer system 1200 can take any suitable physical form. For example, the computer system 1200 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 1200. In some implementations, the computer system 1200 can be an embedded computer system, a system-on-chip (SOC), a single-board computer (SBC) system, or a distributed system such as a mesh of computer systems or include one or more cloud components in one or more networks. Where appropriate, one or more computer systems 1200 can perform operations in real time, near real time, or batch mode.

The network interface device 1212 enables the computer system 1200 to mediate data in a network 1214 with an entity that is external to the computer system 1200 through any communication protocol supported by the computer system 1200 and the external entity. Examples of the network interface device 1212 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1206, non-volatile memory 1210, machine-readable medium 1226) can be local, remote, or distributed. Although shown as a single medium, the machine-readable medium 1226 can include multiple media (e.g., a centralized/distributed database and/or associated caches and servers) that store one or more sets of instructions 1228. The machine-readable medium 1226 can include any medium that is capable of storing, encoding, or carrying a set of instructions for execution by the computer system 1200. The machine-readable medium 1226 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1210, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1204, 1208, 1228) set at various times in various memory and storage devices in computing device(s). When read and executed by the processor 1202, the instruction(s) cause the computer system 1200 to perform operations to execute elements involving the various aspects of the disclosure.

The computer system 1200 can be configured to access a remote language model server (e.g., a cloud-based language model) via the API or the network interface device 1212. For example, the computer system 1200 can communicate with a remote generative AI system to send instructions to and receive content from the generative AI system.

### Example Solutions

Example solutions related to the installation/duplication of templates or library modules are described below.
1. A computer-implemented method of digital rights management for content, comprising: receiving a request from a user for copying information on a source page in a source workspace to a target page in a target workspace, wherein the source page comprises a hierarchical structure of blocks that includes at least a preset format of one or more blocks; and initiating a process to copy the information to the target page, wherein the process comprises: determining, for a block in the preset format of the one or more blocks, that the target workspace has a license for copying the block; and associating a record of the block with the target workspace based on the determining.
2. The computer-implemented method of solution 1, wherein the preset format of the one or more blocks comprises a template of blocks.
3. The computer-implemented method of solution 1 or 2, wherein the copying of the information comprises copying an entirety of the source page.
4. The computer-implemented method of any of solutions 1 to 3, wherein the preset format of the one or more blocks comprises a module of blocks that is part of a library, and wherein the source page further comprises blocks that are not part of the module or the library.
5. The computer-implemented method of any of solutions 1 to 4, wherein the copying of the information comprises installation or duplication of the information.
6. The computer-implemented method of any of solutions 1 to 5, wherein the record comprises information about the copying of the block to the target workspace.
7. The computer-implemented method of any of solutions 1 to 6, wherein the record corresponds to information about the license.
8. The computer-implemented method of any of solutions 1 to 7, wherein the process further comprises: determining, for a block in the hierarchical structure of blocks, whether the block requires validation for the copying.
9. A computer-implemented method of digital rights management for content, comprising: receiving a request from a user for duplicating information on a source page in a source workspace to a target page in a target workspace, wherein the source page comprises a hierarchical structure of blocks that includes at least a preset format of one or more blocks; initiating a duplication process to duplicate the information to the target page, wherein the duplication process comprises: determining, for a block in the preset format of the one or more blocks, that the target workspace fails to have a license for duplicating the block; and replacing the block with a dummy block on the target page.
10. The computer-implemented method of solution 9, wherein the preset format of the one or more blocks comprises a template of blocks.
11. The computer-implemented method of solution 9 or 10, wherein the duplication of the information comprises copying an entirety of the source page.
12. The computer-implemented method of any of solutions 9 to 11, wherein the preset format of the one or more blocks comprises a module of blocks that is part of a library, and wherein the source page further comprises blocks that are not part of the module or the library.
13. The computer-implemented method of any of solutions 9 to 12, wherein the process further comprises: determining, for a block in the hierarchical structure of blocks, whether the block requires validation for the duplicating.
14. A system of digital rights management for content, comprising at least one processor configured to cause the system to: receive a request from a user for copying information on a source page in a source workspace to a target page in a target workspace, wherein the source page comprises a hierarchical structure of blocks that includes at least a preset format of one or more blocks; and copy the information to the target page based on: determining, for a block in the preset format of the one or more blocks, whether the target workspace has a license for copying the block; associating a record of the block with the target workspace upon determining that the target workspace has the license; and replacing the block with a dummy block on the target page upon determining that the target workspace does not have the license.
15. The system of solution 14, wherein the preset format of the one or more blocks comprises a template of blocks.
16. The system of solution 14 or 15, wherein the copying of the information comprises copying an entirety of the source page.
17. The system of any of solutions 14 to 16, wherein the preset format of the one or more blocks comprises a module of blocks that is part of a library, and wherein the source page further comprises blocks that are not part of the module or the library.
18. The system of any of solutions 14 to 17, wherein the copying of the information comprises installation or duplication of the information.
19. The system of any of solutions 14 to 18, wherein the record comprises information about the copying of the block to the target workspace.
20. The system of any of solutions 14 to 19, wherein the record corresponds to information about the license.

Example solutions related to revocation of the license and rendering of the templates/modules are described below.
21. A computer-implemented method of digital rights management for content, comprising: receiving a request from a user to revoke a license associated with a preset format of information; determining, based on the license, one or more locations that have been granted a permission to use the preset format; identifying, in each of the one or more locations, one or more copies of at least part of information included in the preset format; and replacing each of the one or more copies with a dummy part in each of the one or more locations.
22. The computer-implemented method of solution 21, wherein the preset format comprises a template or a module of information.
23. The computer-implemented method of solution 21 or 22, wherein the one or more locations comprises one or more workspaces associated with the user, or one or more pages associated with the user.
24. The computer-implemented method of any of solutions 21 to 23, wherein the one or more locations are determined based on one or more records associated with the preset format created upon part of the preset format being copied to the one or more locations.
25. The computer-implemented method of any of solutions 21 to 24, wherein the preset format comprises a hierarchical structure of blocks.
26. The computer-implemented method of any of solutions 21 to 25, wherein the determining of the one or more locations comprises: determining, for each block in the hierarchical structure of the blocks, one or more records associated with the block; determining, for each record of the one or more records, an operation performed on the block, wherein the operation comprises installing or duplicating the block to a location.
27. The computer-implemented method of any of solutions 21 to 26, comprising: providing a link to the user to renew the license.
28. A non-transitory, computer-readable storage medium comprising instructions recorded thereon, wherein the instructions, when executed by at least one data processor of a system, cause the system to: receive a request from a user to revoke a license associated with a preset format of information; determine, based on the license, one or more locations that have been granted a permission to use the preset format; identify, in each of the one or more locations, one or more copies of at least part of information included in the preset format; and replace each of the one or more copies with a dummy part in each of the one or more locations.
29. The non-transitory, computer-readable storage medium of solution 28, wherein the preset format comprises a template or a module of information.
30. The non-transitory, computer-readable storage medium of solution 28 or 29, wherein the one or more locations comprises one or more workspaces associated with the user, or one or more pages associated with the user.
31. The non-transitory, computer-readable storage medium of any of solutions 28 to 30, wherein the one or more locations are determined based on one or more records associated with the preset format created upon part of the preset format being copied to the one or more locations.
32. The non-transitory, computer-readable storage medium of any of solutions 28 to 31, wherein the preset format comprises a hierarchical structure of blocks.
33. The non-transitory, computer-readable storage medium of any of solutions 28 to 32, wherein the instructions cause the system to: determine, for each block in the hierarchical structure of the blocks, one or more records associated with the block; determine, for each record of the one or more records, an operation performed on the block, wherein the operation comprises installing or duplicating the block to a location.
34. The non-transitory, computer-readable storage medium of any of solutions 28 to 33, wherein the instructions cause the system to: provide an interface to the user to renew the license.
35. A system of digital rights management for content, comprising at least one processor configured to cause the system to: receive a request from a user to revoke a license associated with a preset format of information; determine, based on the license, one or more locations that have been granted a permission to use the preset format; identify, in each of the one or more locations, one or more copies of at least part of information included in the preset format; and replace each of the one or more copies with a dummy part in each of the one or more locations.
36. The system of solution 35, wherein the preset format comprises a template or a module of information.
37. The system of solution 35 or 36, wherein the one or more locations comprises one or more workspaces associated with the user, or one or more pages associated with the user.
38. The system of any of solutions 35 to 37, wherein the one or more locations are determined based on one or more records associated with the preset format created upon part of the preset format being copied to the one or more locations.
39. The system of any of solutions 35 to 38, wherein the preset format comprises a hierarchical structure of blocks, and wherein the at least one processor is configured to cause the system to: determine, for each block in the hierarchical structure of the blocks, one or more records associated with the block; determine, for each record of the one or more records, an operation performed on the block, wherein the operation comprises installing or duplicating the block to a location.
40. The system of any of solutions 35 to 39, wherein the at least one processor is configured to cause the system to: provide an interface to the user to renew the license.

### Remarks

The terms “example,” “embodiment,” and “implementation” are used interchangeably. For example, references to “one example” or “an example” in the disclosure can be, but are not necessarily, references to the same implementation, and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties except for any subject matter disclaimers or disavowals and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms in either this application or in a continuing application.

What is claimed is:

1. A computer-implemented method of digital rights management for content, comprising:
receiving a request from a user for copying information on a source page in a source workspace to a target page in a target workspace,
wherein the source page comprises a hierarchical structure of blocks that includes at least a preset format of one or more blocks; and
initiating a process to copy the information to the target page, wherein the process comprises:
determining, for a block in the preset format of the one or more blocks, that the target workspace has a license for copying the block; and
associating a record of copying the block with the target workspace based on the determining.

2. The computer-implemented method of claim 1, wherein the preset format of the one or more blocks comprises a template of blocks.

3. The computer-implemented method of claim 1, wherein the copying of the information comprises copying an entirety of the source page.

4. The computer-implemented method of claim 1, wherein the preset format of the one or more blocks comprises a module of blocks that is part of a library, and wherein the source page further comprises blocks that are not part of the module or the library.

5. The computer-implemented method of claim 1, wherein the copying of the information comprises installation or duplication of the information.

6. The computer-implemented method of claim 1, wherein the record comprises information about the copying of the block to the target workspace.

7. The computer-implemented method of claim 1, wherein the record corresponds to information about the license.

8. The computer-implemented method of claim 1, wherein the process further comprises:
determining, for a block in the hierarchical structure of blocks, whether the block requires validation for the copying.

9. A computer-implemented method of digital rights management for content, comprising:
receiving a request from a user for duplicating information on a source page in a source workspace to a target page in a target workspace,
wherein the source page comprises a hierarchical structure of blocks that includes at least a preset format of one or more blocks;
initiating a duplication process to duplicate the information to the target page, wherein the duplication process comprises:
determining, for a block in the preset format of the one or more blocks, that the target workspace fails to have a license for duplicating the block; and
replacing the block with a dummy block on the target page.

10. The computer-implemented method of claim 9, wherein the preset format of the one or more blocks comprises a template of blocks.

11. The computer-implemented method of claim 9, wherein the duplication of the information comprises copying an entirety of the source page.

12. The computer-implemented method of claim 9, wherein the preset format of the one or more blocks comprises a module of blocks that is part of a library, and wherein the source page further comprises blocks that are not part of the module or the library.

13. The computer-implemented method of claim 9, wherein the duplication process further comprises:
determining, for a block in the hierarchical structure of blocks, whether the block requires validation for the duplicating.

14. A system of digital rights management for content, comprising at least one processor configured to cause the system to:
receive a request from a user for copying information on a source page in a source workspace to a target page in a target workspace,
wherein the source page comprises a hierarchical structure of blocks that includes at least a preset format of one or more blocks; and
copy the information to the target page based on:
determining, for a block in the preset format of the one or more blocks, whether the target workspace has a license for copying the block;
associating a record of copying the block with the target workspace upon determining that the target workspace has the license; and
replacing the block with a dummy block on the target page upon determining that the target workspace does not have the license.

15. The system of claim 14, wherein the preset format of the one or more blocks comprises a template of blocks.

16. The system of claim 14, wherein the copying of the information comprises copying an entirety of the source page.

17. The system of claim 14, wherein the preset format of the one or more blocks comprises a module of blocks that is part of a library, and wherein the source page further comprises blocks that are not part of the module or the library.

18. The system of claim 14, wherein the copying of the information comprises installation or duplication of the information.

19. The system of claim 14, wherein the record comprises information about the copying of the block to the target workspace.

20. The system of claim 14, wherein the record corresponds to information about the license.
